(19) United States
(12) Patent Application Publication
(10) Pub. No.: US 2026/0136231 A1
(43) Pub. Date: May 14, 2026

(54) DEVICES, METHODS, APPARATUSES, AND COMPUTER READABLE MEDIA FOR NON-TERRESTRIAL NETWORKS

(71) Applicant: Nokia Technologies Oy, Espoo (FI)

(72) Inventors: Ping YUAN, Beijing (CN); Jing HE, Beijing (CN)

(73) Assignee: Nokia Technologies Oy, Espoo (FI)

(21) Appl. No.: 19/118,965

(22) PCT Filed: Oct. 9, 2022
(86) PCT No.: PCT/CN2022/123959

§ 371 Date: Apr. 7, 2025

(51) Int. Cl. H04W 28/02; H04L 47/263; H04L 47/28; H04W 84/06

(52) U.S. Cl. CPC H04W 28/0236; H04L 47/263; H04L 47/28; H04W 84/06

(57) ABSTRACT

Disclosed are devices, methods, apparatuses, and computer readable media for data rate adjustment. An example terminal device may include at least one processor and at least one memory. The at least one memory may store instructions that, when executed by the at least one processor, may cause the terminal device at least to perform: increasing a data rate from a first value to a second value; and transmitting to a network device, an indication indicating the data rate is increased.

### TECHNICAL FIELD

Various example embodiments relate to devices, methods, apparatuses, and computer readable media for non-terrestrial networks (NTN).

### BACKGROUND

NTN is a network or a segment of a network that uses satellites, airborne vehicles, or spaceborne vehicles for transmission. Compared with terrestrial networks (TN), a propagation delay, which may be in terms of a round trip time (RTT), is quite larger for the NTN. For example, in case of a low earth orbit (LEO) satellite with altitude of 600 km and 1200 km, the RTT may be 26 ms and 42 ms, respectively, and for a geostationary orbit satellite (GEO), the RTT may be up to 540 ms. In an example scenario of voice over new radio (VoNR), a user equipment (UE) may generate a voice over internet protocol (VOIP) packet with periodicity of 20 ms. If the UE transmits to the base station (BS) a query medium access control control element (MAC CE) for increasing a data rate, e.g. codec bit rate in this case, assuming that the RTT is 42 ms, the UE may receive from the BS a recommended bit rate (RBR) MAC CE allowing the increased data rate after probably at least 3 VoIP packets. If the network side intends to decrease the data rate, assuming that the RTT is 42 ms, from the UE transmitting to the BS a measurement report to receiving the RBR MAC CE, probably at least 3 VoIP packets has passed.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may store instructions that, when executed by the at least one processor, may cause the terminal device at least to perform: increasing a data rate from a first value to a second value; and transmitting to a network device, an indication indicating the data rate is increased.

In some example embodiments, the indication may comprise at least one of the following: a flag indicating the data rate is increased; the data rate increased from the first value to the second value; or a first timer starting to run upon the network device receiving the indication.

In some example embodiments, the instructions, when executed by the at least one processor, may cause the terminal device to further perform: keeping the data rate in the second value in at least one case of the following: where a response corresponding to the indication is absent from the network device before a second timer starting to run upon transmitting the indication expires; or receiving from the network device, a message acknowledging the indication.

In some example embodiments, the instructions, when executed by the at least one processor, may cause the terminal device to further perform: decreasing the data rate from the second value to the first value in case of receiving from the network device, a message negatively acknowledging the indication before a second timer starting to run upon transmitting the indication expires.

In some example embodiments, the message negatively acknowledging the indication may comprise a third timer starting to run upon receiving the message negatively acknowledging the indication, and the instructions, when executed by the at least one processor, may cause the terminal device to further perform: refraining from increasing the data rate from the first value before the third timer expires.

In some example embodiments, the data rate may be associated with at least one of the following: uplink communication, downlink communication, or uplink communication and downlink communication.

In a second aspect, disclosed is a network device. The network device may include at least one processor and at least one memory. The at least one memory may store instructions that, when executed by the at least one processor, may cause the network device at least to perform: receiving from a terminal device, an indication indicating the data rate is increased; and determining whether to acknowledge or negatively acknowledge the indication.

In some example embodiments, the indication may comprise at least one of the following: a flag indicating the data rate is increased; the data rate increased from a first value to a second value; or a first timer starting to run upon the network device receiving the indication.

In some example embodiments, in case of determining to acknowledge the indication, the instructions, when executed by the at least one processor, may cause the network device to further perform: refraining from transmitting to the terminal device, a response corresponding to the indication before the first timer expires; or transmitting to the terminal device, a message acknowledging the indication before the first timer expires.

In some example embodiments, in case of determining to negatively acknowledge the indication, the instructions, when executed by the at least one processor, may cause the network device to further perform: transmitting to the terminal device, a message negatively acknowledging the indication requiring the terminal device to decrease the data rate before the first timer expires.

In some example embodiments, the message negatively acknowledging the indication may comprise a third timer prohibiting the terminal device from increasing the data rate during the third timer run by the terminal device.

In a third aspect, disclosed is a terminal device. The terminal device may include at least one processor and at least one memory. The at least one memory may store instructions that, when executed by the at least one processor, may cause the terminal device at least to perform: receiving from a network device, a command relating to an adjustment of a data rate; and adjusting the data rate according to the command.

In some example embodiments, the command may comprise a step of the adjustment, and in a case where the command relates to an increase of the data rate, the adjusting of the data rate may comprise: determining whether to increase the data rate; and increasing the data rate by the step or according to a capability of supporting the data rate of the terminal device in case of determining to increase the data rate.

In some example embodiments, refraining from increasing the data rate may be determined in a case where the capability of supporting the data rate increased by the step is absent in the terminal device.

In some example embodiments, whether to increase the data rate may be determined based on at least one of the following: the capability of supporting the data rate of the terminal device; a radio frequency condition of the terminal device; or a requirement from a peer terminal device.

In some example embodiments, the command may comprise a step of the adjustment, and in a case where the command relates to a decrease of the data rate, the adjusting of the data rate may comprise: determining whether to decrease the data rate; and decreasing the data rate by the step or according to a capability of supporting the data rate of the terminal device in case of determining to decrease the data rate.

In some example embodiments, refraining from decreasing the data rate may be determined in a case where the capability of supporting the data rate decreased by the step is absent in the terminal device.

In some example embodiments, whether to decrease the data rate may be determined based on a capability of supporting the data rate of the terminal device.

In a fourth aspect, disclosed is a network device. The network device may include at least one processor and at least one memory. The at least one memory may store instructions that, when executed by the at least one processor, may cause the network device at least to perform: determining whether to instruct a terminal device to adjust a data rate; and transmitting to the terminal device, a command relating to the adjustment of the data rate in case of determining to instruct the terminal device to adjust the data rate.

In some example embodiments, whether to instruct the terminal device to adjust the data rate may be determined based on at least one of the following: overload status of the network device, or capacity requirement of the network device.

In some example embodiments, the command may comprise a step for the terminal device to adjust the data rate.

In some example embodiments, the command may be transmitted in at least one form of the following: unicast, multicast, or broadcast.

In some example embodiments, the command may be associated with at least one of the following: uplink communication of the terminal device, downlink communication of the terminal device, or uplink communication and downlink communication of the terminal device.

In a fifth aspect, disclosed is a method performed by a terminal device. The method may comprise: increasing a data rate from a first value to a second value; and transmitting to a network device, an indication indicating the data rate is increased.

In some example embodiments, the indication may comprise at least one of the following: a flag indicating the data rate is increased; the data rate increased from the first value to the second value; or a first timer starting to run upon the network device receiving the indication.

In some example embodiments, the method may further comprise: keeping the data rate in the second value in at least one case of the following: where a response corresponding to the indication is absent from the network device before a second timer starting to run upon transmitting the indication expires; or receiving from the network device, a message acknowledging the indication.

In some example embodiments, the method may further comprise: decreasing the data rate from the second value to the first value in case of receiving from the network device, a message negatively acknowledging the indication before a second timer starting to run upon transmitting the indication expires.

In some example embodiments, the message negatively acknowledging the indication may comprise a third timer starting to run upon receiving the message negatively acknowledging the indication, and the method may further comprise: refraining from increasing the data rate from the first value before the third timer expires.

In some example embodiments, the data rate may be associated with at least one of the following: uplink communication, downlink communication, or uplink communication and downlink communication.

In a sixth aspect, disclosed is a method performed by a network device. The method may comprise: receiving from a terminal device, an indication indicating the data rate is increased; and determining whether to acknowledge or negatively acknowledge the indication.

In some example embodiments, the indication may comprise at least one of the following: a flag indicating the data rate is increased; the data rate increased from a first value to a second value; or a first timer starting to run upon the network device receiving the indication.

In some example embodiments, in case of determining to acknowledge the indication, the method may further comprise: refraining from transmitting to the terminal device, a response corresponding to the indication before the first timer expires; or transmitting to the terminal device, a message acknowledging the indication before the first timer expires.

In some example embodiments, in case of determining to negatively acknowledge the indication, the method may further comprise: transmitting to the terminal device, a message negatively acknowledging the indication requiring the terminal device to decrease the data rate before the first timer expires.

In some example embodiments, the message negatively acknowledging the indication may comprise a third timer prohibiting the terminal device from increasing the data rate during the third timer run by the terminal device.

In a seventh aspect, disclosed is a method performed by a terminal device. The method may comprise: receiving from a network device, a command relating to an adjustment of a data rate; and adjusting the data rate according to the command.

In some example embodiments, the command may comprise a step of the adjustment, and in a case where the command relates to an increase of the data rate, the adjusting of the data rate may comprise: determining whether to increase the data rate; and increasing the data rate by the step or according to a capability of supporting the data rate of the terminal device in case of determining to increase the data rate.

In some example embodiments, refraining from increasing the data rate may be determined in a case where the capability of supporting the data rate increased by the step is absent in the terminal device.

In some example embodiments, whether to increase the data rate may be determined based on at least one of the following: the capability of supporting the data rate of the terminal device; a radio frequency condition of the terminal device; or a requirement from a peer terminal device.

In some example embodiments, the command may comprise a step of the adjustment, and in a case where the command relates to a decrease of the data rate, the adjusting of the data rate may comprise: determining whether to decrease the data rate; and decreasing the data rate by the step or according to a capability of supporting the data rate of the terminal device in case of determining to decrease the data rate.

In some example embodiments, refraining from decreasing the data rate may be determined in a case where the capability of supporting the data rate decreased by the step is absent in the terminal device.

In some example embodiments, whether to decrease the data rate may be determined based on a capability of supporting the data rate of the terminal device.

In an eighth aspect, disclosed is a method performed by a network device. The method may comprise: determining whether to instruct a terminal device to adjust a data rate; and transmitting to the terminal device, a command relating to the adjustment of the data rate in case of determining to instruct the terminal device to adjust the data rate.

In some example embodiments, whether to instruct the terminal device to adjust the data rate may be determined based on at least one of the following: overload status of the network device, or capacity requirement of the network device.

In some example embodiments, the command may comprise a step for the terminal device to adjust the data rate.

In some example embodiments, the command may be transmitted in at least one form of the following: unicast, multicast, or broadcast.

In some example embodiments, the command may be associated with at least one of the following: uplink communication of the terminal device, downlink communication of the terminal device, or uplink communication and downlink communication of the terminal device.

In a ninth aspect, disclosed is an apparatus. The apparatus as a terminal device may comprise: means for increasing a data rate from a first value to a second value; and means for transmitting to a network device, an indication indicating the data rate is increased.

In some example embodiments, the indication may comprise at least one of the following: a flag indicating the data rate is increased; the data rate increased from the first value to the second value; or a first timer starting to run upon the network device receiving the indication.

In some example embodiments, the apparatus may further comprise: means for keeping the data rate in the second value in at least one case of the following: where a response corresponding to the indication is absent from the network device before a second timer starting to run upon transmitting the indication expires; or receiving from the network device, a message acknowledging the indication.

In some example embodiments, the apparatus may further comprise: means for decreasing the data rate from the second value to the first value in case of receiving from the network device, a message negatively acknowledging the indication before a second timer starting to run upon transmitting the indication expires.

In some example embodiments, the message negatively acknowledging the indication may comprise a third timer starting to run upon receiving the message negatively acknowledging the indication, and the apparatus may further comprise: means for refraining from increasing the data rate from the first value before the third timer expires.

In some example embodiments, the data rate may be associated with at least one of the following: uplink communication, downlink communication, or uplink communication and downlink communication.

In a tenth aspect, disclosed is an apparatus. The apparatus as a network device may comprise: means for receiving from a terminal device, an indication indicating the data rate is increased; and means for determining whether to acknowledge or negatively acknowledge the indication.

In some example embodiments, the indication may comprise at least one of the following: a flag indicating the data rate is increased; the data rate increased from a first value to a second value; or a first timer starting to run upon the network device receiving the indication.

In some example embodiments, in case of determining to acknowledge the indication, the apparatus may further comprise: means for refraining from transmitting to the terminal device, a response corresponding to the indication before the first timer expires; or means for transmitting to the terminal device, a message acknowledging the indication before the first timer expires.

In some example embodiments, in case of determining to negatively acknowledge the indication, the apparatus may further comprise: means for transmitting to the terminal device, a message negatively acknowledging the indication requiring the terminal device to decrease the data rate before the first timer expires.

In some example embodiments, the message negatively acknowledging the indication may comprise a third timer prohibiting the terminal device from increasing the data rate during the third timer run by the terminal device.

In an eleventh aspect, disclosed is an apparatus. The apparatus as a terminal device may comprise: means for receiving from a network device, a command relating to an adjustment of a data rate; and means for adjusting the data rate according to the command.

In some example embodiments, the command may comprise a step of the adjustment, and in a case where the command relates to an increase of the data rate, the adjusting of the data rate may comprise: determining whether to increase the data rate; and increasing the data rate by the step or according to a capability of supporting the data rate of the terminal device in case of determining to increase the data rate.

In some example embodiments, refraining from increasing the data rate may be determined in a case where the capability of supporting the data rate increased by the step is absent in the terminal device.

In some example embodiments, whether to increase the data rate may be determined based on at least one of the following: the capability of supporting the data rate of the terminal device; a radio frequency condition of the terminal device; or a requirement from a peer terminal device.

In some example embodiments, the command may comprise a step of the adjustment, and in a case where the command relates to a decrease of the data rate, the adjusting of the data rate may comprise: determining whether to decrease the data rate; and decreasing the data rate by the step or according to a capability of supporting the data rate of the terminal device in case of determining to decrease the data rate.

In some example embodiments, refraining from decreasing the data rate may be determined in a case where the capability of supporting the data rate decreased by the step is absent in the terminal device.

In some example embodiments, whether to decrease the data rate may be determined based on a capability of supporting the data rate of the terminal device.

In a twelfth aspect, disclosed is an apparatus. The apparatus as a network device may comprise: means for determining whether to instruct a terminal device to adjust a data rate; and means for transmitting to the terminal device, a command relating to the adjustment of the data rate in case of determining to instruct the terminal device to adjust the data rate.

In some example embodiments, whether to instruct the terminal device to adjust the data rate may be determined based on at least one of the following: overload status of the network device, or capacity requirement of the network device.

In some example embodiments, the command may comprise a step for the terminal device to adjust the data rate.

In some example embodiments, the command may be transmitted in at least one form of the following: unicast, multicast, or broadcast.

In some example embodiments, the command may be associated with at least one of the following: uplink communication of the terminal device, downlink communication of the terminal device, or uplink communication and downlink communication of the terminal device.

In a thirteenth aspect, a computer readable medium is disclosed. The computer readable medium may comprise program instructions that, when executed by a terminal device, cause the terminal device at least to perform: increasing a data rate from a first value to a second value; and transmitting to a network device, an indication indicating the data rate is increased.

In some example embodiments, the indication may comprise at least one of the following: a flag indicating the data rate is increased; the data rate increased from the first value to the second value; or a first timer starting to run upon the network device receiving the indication.

In some example embodiments, the computer readable medium may further comprise instructions that, when executed by the terminal device, may cause the network device to further perform: keeping the data rate in the second value in at least one case of the following: where a response corresponding to the indication is absent from the network device before a second timer starting to run upon transmitting the indication expires; or receiving from the network device, a message acknowledging the indication.

In some example embodiments, the computer readable medium may further comprise instructions that, when executed by the terminal device, may cause the network device to further perform: decreasing the data rate from the second value to the first value in case of receiving from the network device, a message negatively acknowledging the indication before a second timer starting to run upon transmitting the indication expires.

In some example embodiments, the message negatively acknowledging the indication may comprise a third timer starting to run upon receiving the message negatively acknowledging the indication, and the computer readable medium may further comprise instructions that, when executed by the terminal device, may cause the network device to further perform: refraining from increasing the data rate from the first value before the third timer expires.

In some example embodiments, the data rate may be associated with at least one of the following: uplink communication, downlink communication, or uplink communication and downlink communication.

In a fourteenth aspect, a computer readable medium is disclosed. The computer readable medium may comprise program instructions that, when executed by a network device, cause the network device at least to perform: receiving from a terminal device, an indication indicating the data rate is increased; and determining whether to acknowledge or negatively acknowledge the indication.

In some example embodiments, the indication may comprise at least one of the following: a flag indicating the data rate is increased; the data rate increased from a first value to a second value; or a first timer starting to run upon the network device receiving the indication.

In some example embodiments, in case of determining to acknowledge the indication, the computer readable medium may further comprise instructions that, when executed by the network device, may cause the network device to further perform: refraining from transmitting to the terminal device, a response corresponding to the indication before the first timer expires; or transmitting to the terminal device, a message acknowledging the indication before the first timer expires.

In some example embodiments, in case of determining to negatively acknowledge the indication, the computer readable medium may further comprise instructions that, when executed by the network device, may cause the network device to further perform: transmitting to the terminal device, a message negatively acknowledging the indication requiring the terminal device to decrease the data rate before the first timer expires.

In some example embodiments, the message negatively acknowledging the indication may comprise a third timer prohibiting the terminal device from increasing the data rate during the third timer run by the terminal device.

In a fifteenth aspect, a computer readable medium is disclosed. The computer readable medium may comprise program instructions that, when executed by a terminal device, cause the terminal device at least to perform: receiving from a network device, a command relating to an adjustment of a data rate; and adjusting the data rate according to the command.

In some example embodiments, the command may comprise a step of the adjustment, and in a case where the command relates to an increase of the data rate, the adjusting of the data rate may comprise: determining whether to increase the data rate; and increasing the data rate by the step or according to a capability of supporting the data rate of the terminal device in case of determining to increase the data rate.

In some example embodiments, refraining from increasing the data rate may be determined in a case where the capability of supporting the data rate increased by the step is absent in the terminal device.

In some example embodiments, whether to increase the data rate may be determined based on at least one of the following: the capability of supporting the data rate of the terminal device; a radio frequency condition of the terminal device; or a requirement from a peer terminal device.

In some example embodiments, the command may comprise a step of the adjustment, and in a case where the command relates to a decrease of the data rate, the adjusting of the data rate may comprise: determining whether to decrease the data rate; and decreasing the data rate by the step or according to a capability of supporting the data rate of the terminal device in case of determining to decrease the data rate.

In some example embodiments, refraining from decreasing the data rate may be determined in a case where the capability of supporting the data rate decreased by the step is absent in the terminal device.

In some example embodiments, whether to decrease the data rate may be determined based on a capability of supporting the data rate of the terminal device.

In a sixteenth aspect, a computer readable medium is disclosed. The computer readable medium may comprise program instructions that, when executed by a network device, cause the network device at least to perform: determining whether to instruct a terminal device to adjust a data rate; and transmitting to the terminal device, a command relating to the adjustment of the data rate in case of determining to instruct the terminal device to adjust the data rate.

In some example embodiments, whether to instruct the terminal device to adjust the data rate may be determined based on at least one of the following: overload status of the network device, or capacity requirement of the network device.

In some example embodiments, the command may comprise a step for the terminal device to adjust the data rate.

In some example embodiments, the command may be transmitted in at least one form of the following: unicast, multicast, or broadcast.

In some example embodiments, the command may be associated with at least one of the following: uplink communication of the terminal device, downlink communication of the terminal device, or uplink communication and downlink communication of the terminal device.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for data rate adjustment according to the example embodiments of the present disclosure.

FIG. 2 shows an exemplary sequence diagram for data rate adjustment according to the example embodiments of the present disclosure.

FIG. 3 shows a flow chart illustrating an example method 300 for data rate adjustment according to the example embodiments of the present disclosure.

FIG. 4 shows a flow chart illustrating an example method 400 for data rate adjustment according to the example embodiments of the present disclosure.

FIG. 5 shows a flow chart illustrating an example method 500 for data rate adjustment according to the example embodiments of the present disclosure.

FIG. 6 shows a flow chart illustrating an example method 600 for data rate adjustment according to the example embodiments of the present disclosure.

FIG. 7 shows a block diagram illustrating an example device 700 for data rate adjustment according to the example embodiments of the present disclosure.

FIG. 8 shows a block diagram illustrating an example device 800 for data rate adjustment according to the example embodiments of the present disclosure.

FIG. 9 shows a block diagram illustrating an example device 900 for data rate adjustment according to the example embodiments of the present disclosure.

FIG. 10 shows a block diagram illustrating an example device 1000 for data rate adjustment according to the example embodiments of the present disclosure.

FIG. 11 shows a block diagram illustrating an example apparatus 1100 for data rate adjustment according to the example embodiments of the present disclosure.

FIG. 12 shows a block diagram illustrating an example apparatus 1200 for data rate adjustment according to the example embodiments of the present disclosure.

FIG. 13 shows a block diagram illustrating an example apparatus 1300 for data rate adjustment according to the example embodiments of the present disclosure.

FIG. 14 shows a block diagram illustrating an example apparatus 1400 for data rate adjustment according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for data rate adjustment in the NTN. According to the example embodiments of the present disclosure, the data rate adjustment may be implemented under minimum impact of the large propagation delay of the NTN.

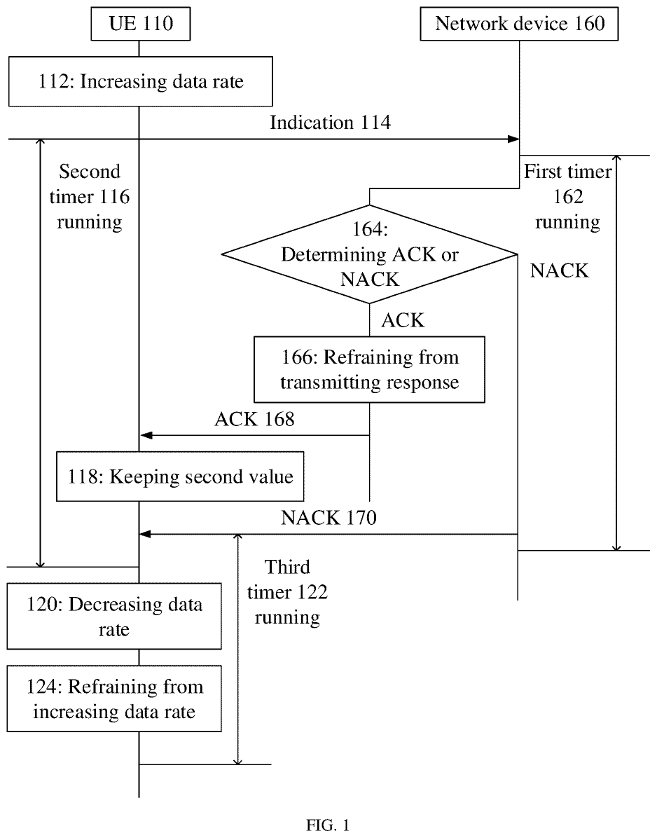

FIG. 1 shows an exemplary sequence diagram for data rate adjustment according to the example embodiments of the present disclosure. Referring to the FIG. 1, a UE 110 may represent any terminal device, for example, in the NTN. A network device 160 may function as a BS, e.g. a next generation node B (gNB), an evolved node B (eNB), a centralized unit (CU), a distributed unit (DU), a combination of a CU and a DU, or alike, which may serve the UE 110, in the NTN.

In an operation 112, the UE 110 may increase a data rate from a first value to a second value. For example, in a case where a radio frequency (RF) condition of the UE 110 is improved and/or a peer UE communicating with the UE 110 requires the UE 110 to increase the data rate, if the UE 110 can support a higher data rate, the UE 110 may increase the data rate on its own initiative without transmitting a MAC CE to the network device 160 for data rate query in advance. In an example scenario of the VoNR, for example, the UE 110 may increase the codec adaptive multi-rate (AMR) from e.g. 4.75 kbps to e.g. 5.9 kbps or 7.4 kbps in order to utilize a higher definition voice call.

Slightly after or in parallel with the increase of the data rate, the UE 110 may transmit to the network device 160, an indication 114 indicating the data rate is increased. In an embodiment, the indication 114 may comprise at least one of the following: a flag indicating the data rate is increased; the data rate increased from the first value to the second value; or a first timer 162 starting to run upon the network device 160 receiving the indication 114.

For example, the indication 114 may be a flag of e.g. 1 bit in an uplink (UL) MAC CE to notify the network device 160 that the data rate is increased. Alternatively, the indication 114 may include the data rate increased from the first value to the second value, for example, the specific first value e.g. 4.75 kbps and the specific second value e.g. 5.15 kbps, such that the network device 160 may be aware of the data rate of the UE 110 before and after the increase.

Optionally, the indication 114 may include a first timer 162 which will start to run when the network device 160 receives the indication 114. The first timer 162 runs on the side of the network device 160 and may request the network device 160 to make determination regarding acknowledging or negatively acknowledging and transmit the corresponding message before the expiration of the first timer 162. On the side of the UE 110, optionally a second timer 116 may start to run when the UE 110 transmits the indication 114, the duration of the second timer 116 may be around the duration of the first timer 162 plus a RTT between the UE 110 and the network device 160. For example, although the network device 160 does not acknowledge the indication 114, if the network device 160 transmit the message negatively acknowledging the indication 114 e.g. a non-acknowledgment (NACK) message 170, after the first timer 162 expires, the UE 110 may probably receive the NACK message 170 after the expiration of the second timer 116. In this case, the UE 110 may ignore the NACK message 170 and not to decrease the data rate according to the NACK message 170. The first timer 162 and/or the second timer 116 may be termed as a waiting timer.

Receiving the indication 114, in an operation 164, the network device 160 may determine whether to acknowledge or negatively acknowledge the indication 114. For example, if overload status of the network device 160 is relatively light and/or capacity requirement of the network device 160 is low, for example the number of the UEs served by the network device 160 is relatively low, the network device 160 may determine to acknowledge the indication 114. On the contrary, if the overload status of the network device 160 is relatively heavy and/or capacity requirement of the network device 160 is high, for example the number of the UEs served by the network device 160 is relatively high, the network device 160 may determine to negatively acknowledge the indication 114, i.e. not to acknowledge the indication 114.

In case of determining to acknowledge the indication 114 (“ACK” prong of the operation 164), in an embodiment, the network device 160 may transmit to the UE 110 a message 168 acknowledging the indication 114, i.e. an acknowledgment (ACK) message 168, before the first timer 162 expires. The ACK message 168 may be implemented as a flag in a downlink (DL) MAC CE. In this case, on the side of the UE 110, the UE 110 may probably receive the message 168 acknowledging the indication 114, i.e. the ACK message 168 before the second timer 116 expires. Receiving the ACK message 168, in an operation 118 the UE 110 may keeping the data rate in the second value.

In case of determining to acknowledge the indication 114 (“ACK” prong of the operation 164), alternatively, in an embodiment, in an operation 166 the network device 160 may refrain from transmitting to the UE 110, a response corresponding to the indication 114 before the first timer 162 expires. In this case, on the side of the UE 110, the UE 110 probably cannot receive the response corresponding to the indication 114 before the second timer 116 expires. In a case where the response corresponding to the indication 114 is absent from the network device 160 before the second timer 116 expires, in the operation 118 the UE 110 may keep the data rate in the second value.

In case of determining to negatively acknowledge the indication 114, (“NACK” prong of the operation 164), in an embodiment, the network device 160 may transmit to the UE 110 a message 170 negatively acknowledging the indication 114, i.e. a NACK message 170, before the first timer 162 expires. The NACK message 170 may require the UE 110 to decrease the data rate, e.g. back to the first value. In an embodiment, the NACK message 170 may be implemented as a flag in a DL MAC CE. For example, the NACK message 170 and the ACK message 168 may be carried by an identical flag in the DL MAC CE, and different values of the flag, e.g. 0 or 1 may indicate the ACK message 168 or the NACK message 170. In this case, on the side of the UE 110, the UE 110 may probably receive the message 170 negatively acknowledging the indication 114, i.e. the NACK message 170 before the second timer 116 expires. Receiving the NACK message 170 before the second timer 116 expires, in an operation 120 the UE 110 will decrease the data rate from the second value to the first value.

In the FIG. 1, the operation 120 is shown after the second timer 116 expires, and it may be appreciated that the UE 110 may perhaps perform the operation 120 before the second timer 116 expires or in parallel with the expiration of the second timer 116.

In an embodiment, the NACK message 170 may comprise a third timer 122. The third timer 122 may be run by the UE 110. For example, the third timer 122 may start to run upon the UE 110 receiving the NACK message 170. The third timer 122 may prohibit the UE 110 from increasing the data rate during the running of the third timer 122 and thus may be termed as a blocking timer. In a case where the NACK message 170 comprises the third timer 122, in an operation 124, the UE 110 will refrain from increasing the data rate from the first value before the third timer 122 expires.

In the example embodiments with respect to the FIG. 1, the data rate may be associated with at least one of the following: UL communication, DL communication, or UL communication and DL communication. For example, the operation(s) may be performed on the data rate associated with the UL communication of the UE 110, which may be, for example, the communication from the UE 110 to a peer UE via the network side. Alternatively or additionally, the operation(s) may be performed on the data rate associated with the DL communication of the UE 110, which may be, for example, the communication from the peer UE to the UE 110 via the network side. Alternatively or additionally, the operation(s) may be performed on the data rate associated with both the UL and the DL communications of the UE 110.

As an option, the network device 160 may transmit to the UE 110 a signaling to enable the UE 110 to increase the data rate on its own initiative. In other words, the enabling signaling may be a precondition for the UE 110 to increase the data rate on its own initiative, and the network device 160 is allowed to perform the operation 112 after receiving the enabling signaling. The enabling signaling may be broadcast to UEs including the UE 110 in a NTN cell via a system information block (SIB). Alternatively or additionally, the enabling signaling may be multicast to a group of UEs including the UE 110. Alternatively or additionally, the enabling signaling may be unicast to the UE 110. Without the enabling signaling, in a case where the UE 110 needs to increase the data rate, the UE 110 may transmit to the network device 160 a request for increasing the data rate via e.g. an UL MAC CE, and will increase the data rate after receiving from the network device 160 a response acknowledging the request.

The example embodiments of the present disclosure can overcome NTN long propagation delay such that a UE can enjoy high data rate service immediately while the network side still keeps controlling to the indication from such UE, so as to avoid unexpected worse impacting to whole cell/system capacity and load situation.

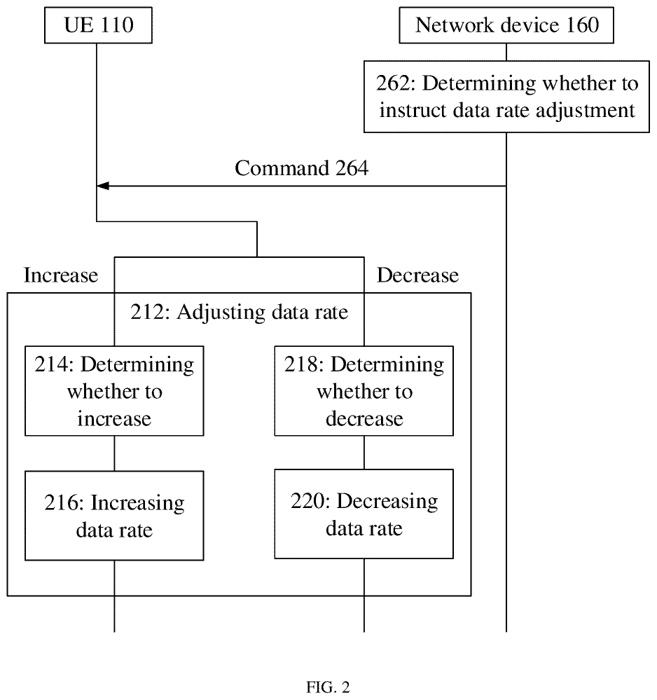

FIG. 2 shows an exemplary sequence diagram for data rate adjustment according to the example embodiments of the present disclosure. The UE 110 and the network device 160 may also operate in the example embodiments with respect to the FIG. 2.

In an operation 262, the network device 160 may determine whether to instruct the UEs served by the network device 160 to adjust a data rate. Here the UE 110 represents any of the UEs served by the network device 160.

In an embodiment, whether to instruct the UE 110 to adjust the data rate may be determined based on at least one of the following: overload status of the network device 160, or capacity requirement of the network device 160. For example, if overload status of the network device 160 is relatively light and/or capacity requirement of the network device 160 is low, for example the number of the UEs served by the network device 160 is relatively low, the network device 160 may determine to instruct the UE 110 to increase the data rate. On the contrary, if the overload status of the network device 160 is relatively heavy and/or capacity requirement of the network device 160 is high, for example the number of the UEs served by the network device 160 is relatively high, the network device 160 may determine to instruct the UE 110 to decrease the data rate.

In case of determining to instruct the UE 110 to adjust the data rate, the network device 160 may transmit to the UE 110, a command 264 relating to the adjustment of the data rate. The command 264 may be transmitted in at least one form of the following: unicast, multicast, or broadcast. For example, the network device 160 may broadcast the command 264 to the served UEs. Alternatively or additionally, the network device 160 may multicast the command 264 to a group of served UEs. Alternatively or additionally, the network device 160 may unicast the command 264 to the UE 110.

Moreover, the command 264 may be associated with at least one of the following: UL communication of the UE 110, DL communication of the UE 110, or UL communication and DL communication of the UE 110. For example, the network device 160 may instruct the UE 110 to adjust the data rate associated with the UL communication of the UE 110, which may be, for example, the communication from the UE 110 to a peer UE via the network side. Alternatively or additionally, the network device 160 may instruct the UE 110 to adjust the data rate associated with the DL communication of the UE 110, which may be, for example, the communication from the peer UE to the UE 110 via the network side. Alternatively or additionally, the network device 160 may instruct the UE 110 to adjust the data rate associated with both the UL and the DL communications of the UE 110.

In an embodiment, the command 264 may comprise a step for the UE 110 to adjust the data rate. The step may be a difference value X for the UE 110 to increase or decrease the data rate. For example, the command 264 comprising the step may instruct the UE 110 to increase or decrease the data rate by the difference value X. Alternatively or additionally, the step may be a percentage value Y for the UE 110 to increase or decrease the data rate. For example, the command 264 comprising the step may instruct the UE 110 to increase or decrease the data rate by the percentage value Y.

Alternatively or additionally, the step may be a level number N for the UE 110 to increase or decrease the data rate. For example, in the example scenario of the VoNR, the UE 110 and the network device 160 have the common understanding on the codec AMR levels and the corresponding codec bit rates like the Table 1 below.

TABLE 1

| Level | 1 | 2 | 3 | 4 | 5 | 6 | 7 | 8 |
|---|---|---|---|---|---|---|---|---|
| Rate in kbps | 4.75 | 5.15 | 5.9 | 6.7 | 7.4 | 7.95 | 10.2 | 12.2 |

In this case, the command 264 comprising the step may instruct the UE 110 to increase or decrease the data rate by the level number N. For example, if the command 264 comprising level number 2 relates to an increase of the data rate, the command 264 may instruct the UE 110 to increase the data rate by 2 levels, for example, from 5.15 kbps to 6.7 kbps, or from 7.4 kbps to 10.2 kbps, etc. For example, if the command 264 comprising level number 1 relates to a decrease of the data rate, the command 264 may instruct the UE 110 to decrease the data rate by 1 level, for example, from 5.15 kbps to 4.75 kbps, or from 7.4 kbps to 6.7 kbps, etc.

Receiving from the network device 160, the command 264, in an operation 212, the UE 110 may adjust the data rate according to the command 264.

In a case where the command 264 relates to the increase of the data rate (“Increase” prong in the FIG. 2), in the operation 212 for the adjusting of the data rate, the UE 110 may determine whether to increase the data rate in an operation 214. In an embodiment, in the operation 214, the UE 110 may determine whether to increase the data rate based on at least one of the following: a capability of supporting the data rate of the UE 110; a RF condition of the UE 110; or a requirement from a peer UE. For example, in a case where the RF condition of the UE 110 is good and/or the peer UE communicating with the UE 110 requires the UE 110 to increase the data rate, if the UE 110 has the capability of supporting the data rate increased by the step, in the operation 214, the UE 110 may determine to increase the data rate. In this case, in an operation 216, the UE 110 may increase the data rate by the step.

Alternatively, in a case where the UE 110 has no the capability of supporting the data rate increased by the step but can support the data rate increased by some level, in the operation 214, the UE 110 may still determine to increase the data rate. In this case, in the operation 216, the UE 110 may increase the data rate according to the capability of supporting the data rate of the UE 110. For example, assuming that the UE 110 is current using the codec AMR level 6, i.e. 7.95 kbps according to the Table 1, and the command 264 relating to the increase of the data rate comprises a step of level number 2, if the UE 110 has no capability of supporting the data rate of the codec AMR level 8, i.e. 12.2 kbps, which is increased by 2 levels, but has the capability of supporting the data rate of the codec AMR level 7, i.e. 10.2 kbps, which is increased by 1 level, in the operation 214, the UE 110 may determine to increase the data rate. In this case, in the operation 216, the UE 110 may increase the data rate by 1 level to the codec AMR level 7 according to the capability of supporting the data rate of the UE 110.

Alternatively, for example, in a case where the RF condition of the UE 110 is not good enough and/or the UE 110 has no the capability of supporting a higher data rate, in the operation 214, the UE 110 may determine not to increase the data rate. For example, if the UE 110 is currently using the codec AMR level 7, i.e. 10.2 kbps according to the Table 1, and the command 264 relating to the increase of the data rate comprises a step of level number 1, but the UE 110 cannot support the codec AMR level 8. i.e. 12.2 kbps, in the operation 214, the UE 110 may determine not to increase the data rate and will not perform the operation 216. Alternatively, in a case where the capability of supporting the data rate increased by the step is absent in the UE 110, for example, assuming that the UE 110 is current using the codec AMR level 6, i.e. 7.95 kbps, and the command 264 relating to the increase of the data rate comprises a step of level number 2, if the UE 110 has no capability of supporting the data rate of the codec AMR level 8, i.e. 12.2 kbps, even if the UE 110 has the capability of supporting the data rate of the codec AMR level 7, i.e. 10.2 kbps, in the operation 214, the UE 110 may determine refraining from increasing the data rate, i.e. not to increase the data rate, and will not perform the operation 216.

In a case where the command 264 relates to the decrease of the data rate (“Decrease” prong in the FIG. 2), in the operation 212 for the adjusting of the data rate, the UE 110 may determine whether to decrease the data rate in an operation 218. In an embodiment, in the operation 218, the UE 110 may determine whether to decrease the data rate based on a capability of supporting the data rate of the UE 110. For example, assuming that the UE 110 is currently using the codec AMR level 3, i.e. 5.9 kbps according to the Table 1, and the command 264 relating to the decrease of the data rate comprises a step of level number 2, if the UE 110 has the capability of supporting the codec AMR level 1, i.e. 4.75 kbps, in the operation 218, the UE 110 may determine to decrease the data rate. In this case, in an operation 220, the UE 110 may decrease the data rate by the step.

Alternatively, in a case where the UE 110 has no the capability of supporting the data rate decreased by the step but can support the data rate decreased by some level, in the operation 218, the UE 110 may still determine to decrease the data rate. In this case, in the operation 220, the UE 110 may decrease the data rate according to the capability of supporting the data rate of the UE 110. For example, assuming that the UE 110 is current using the codec AMR level 6, i.e. 7.95 kbps according to the Table 1, and the command 264 relating to the decrease of the data rate comprises a step of level number 2, if the UE 110 has no capability of supporting the data rate of the codec AMR level 4, i.e. 6.7 kbps, which is decreased by 2 levels, but has the capability of supporting the data rate of the codec AMR level 5, i.e. 7.4 kbps, which is decreased by 1 level, in the operation 218, the UE 110 may determine to decrease the data rate. In this case, in the operation 220, the UE 110 may decrease the data rate by 1 level to the codec AMR level 5 according to the capability of supporting the data rate of the UE 110.

Alternatively, for example, in a case where the UE 110 has no the capability of supporting a lower data rate, in the operation 218, the UE 110 may determine not to decrease the data rate. For example, if the UE 110 is currently using the codec AMR level 2. i.e. 5.15 kbps according to the Table 1, and the command 264 relating to the increase of the data rate comprises a step of level number 1, but the UE 110 cannot support the codec AMR level 1, i.e. 4.75 kbps, in the operation 218, the UE 110 may determine not to decrease the data rate and will not perform the operation 220. Alternatively, in a case where the capability of supporting the data rate decreased by the step is absent in the UE 110, for example, assuming that the UE 110 is current using the codec AMR level 3, i.e. 5.9 kbps, and the command 264 relating to the decrease of the data rate comprises a step of level number 2, if the UE 110 has no capability of supporting the data rate of the codec AMR level 1, i.e. 4.75 kbps, even if the UE 110 has the capability of supporting the data rate of the codec AMR level 2, i.e. 5.15 kbps, in the operation 218, the UE 110 may determine refraining from decreasing the data rate, i.e. not to decrease the data rate, and will not perform the operation 220.

The example embodiments of the present disclosure can overcome NTN long propagation delay and can achieve quick data rate controlling to the UEs served in one NTN cell, in case that the current cell is facing overload issue.

The example embodiments of the present disclosure can also support the co-existence between broadcast-based and MAC CE-based data rate adjustment in the NTN, for example, new radio (NR) NTN.

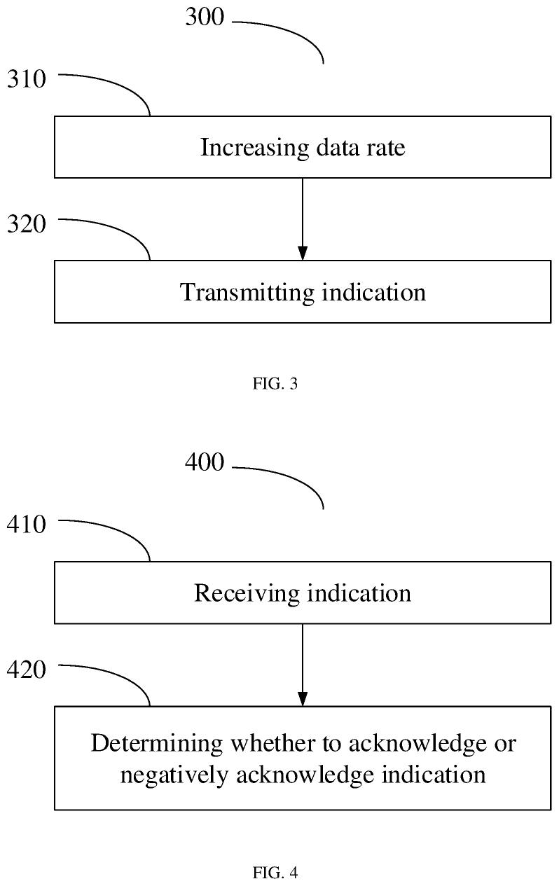

FIG. 3 shows a flow chart illustrating an example method 300 for data rate adjustment according to the example embodiments of the present disclosure. The example method 300 may be performed for example by a terminal device such as the UE 110.

Referring to the FIG. 3, the example method 300 may include an operation 310 of increasing a data rate from a first value to a second value; and an operation 320 of transmitting to a network device, an indication indicating the data rate is increased.

Details of the operation 310 have been described in the above descriptions with respect to at least the operation 112, and repetitive descriptions thereof are omitted here.

Details of the operation 320 have been described in the above descriptions with respect to at least the indication 114, and repetitive descriptions thereof are omitted here.

In an embodiment, the indication may comprise at least one of the following: a flag indicating the data rate is increased; the data rate increased from the first value to the second value; or a first timer starting to run upon the network device receiving the indication. The more details have been described in the above descriptions with respect to at least the indication 114 and the first timer 162, and repetitive descriptions thereof are omitted here.

In an embodiment, the example method 300 may further include an operation of keeping the data rate in the second value in at least one case of the following: where a response corresponding to the indication is absent from the network device before a second timer starting to run upon transmitting the indication expires; or receiving from the network device, a message acknowledging the indication. The more details have been described in the above descriptions with respect to at least the operation 118, the ACK message 168, the first timer 162, and the operation 166, and repetitive descriptions thereof are omitted here.

In an embodiment, the example method 300 may further include an operation of decreasing the data rate from the second value to the first value in case of receiving from the network device, a message negatively acknowledging the indication before a second timer starting to run upon transmitting the indication expires. The more details have been described in the above descriptions with respect to at least the operation 120, the NACK message 170, and the second timer 116, and repetitive descriptions thereof are omitted here.

In an embodiment, the message negatively acknowledging the indication may comprise a third timer starting to run upon receiving the message negatively acknowledging the indication, and the example method 300 may further include an operation of refraining from increasing the data rate from the first value before the third timer expires. The more details have been described in the above descriptions with respect to at least the NACK message 170, the operation 124, and the third timer 122, and repetitive descriptions thereof are omitted here.

In an embodiment, the data rate may be associated with at least one of the following: UL communication, DL communication, or UL communication and DL communication.

FIG. 4 shows a flow chart illustrating an example method 400 for data rate adjustment according to the example embodiments of the present disclosure. The example method 400 may be performed for example by a network device such as the network device 160.

Referring to the FIG. 4, the example method 400 may include an operation 410 of receiving from a terminal device, an indication indicating the data rate is increased; and an operation 420 of determining whether to acknowledge or negatively acknowledge the indication.

Details of the operation 410 have been described in the above descriptions with respect to at least the indication 114, and repetitive descriptions thereof are omitted here.

Details of the operation 420 have been described in the above descriptions with respect to at least the operation 164, and repetitive descriptions thereof are omitted here.

In an embodiment, the indication may comprise at least one of the following: a flag indicating the data rate is increased; the data rate increased from a first value to a second value; or a first timer starting to run upon the network device receiving the indication. The more details have been described in the above descriptions with respect to at least the indication 114, and repetitive descriptions thereof are omitted here.

In an embodiment, in case of determining to acknowledge the indication, the example method 400 may further include an operation of refraining from transmitting to the terminal device, a response corresponding to the indication before the first timer expires; or an operation of transmitting to the terminal device, a message acknowledging the indication before the first timer expires. The more details have been described in the above descriptions with respect to at least the operation 166, the ACK message 168, and the first timer 162, and repetitive descriptions thereof are omitted here.

In an embodiment, in case of determining to negatively acknowledge the indication, the example method 400 may further include an operation of transmitting to the terminal device, a message negatively acknowledging the indication requiring the terminal device to decrease the data rate before the first timer expires. The more details have been described in the above descriptions with respect to at least the NACK message 170 and the first timer 162, and repetitive descriptions thereof are omitted here.

In an embodiment, the message negatively acknowledging the indication may comprise a third timer prohibiting the terminal device from increasing the data rate during the third timer run by the terminal device. The more details have been described in the above descriptions with respect to at least the NACK message 170, the third timer 122 and the operation 124, and repetitive descriptions thereof are omitted here.

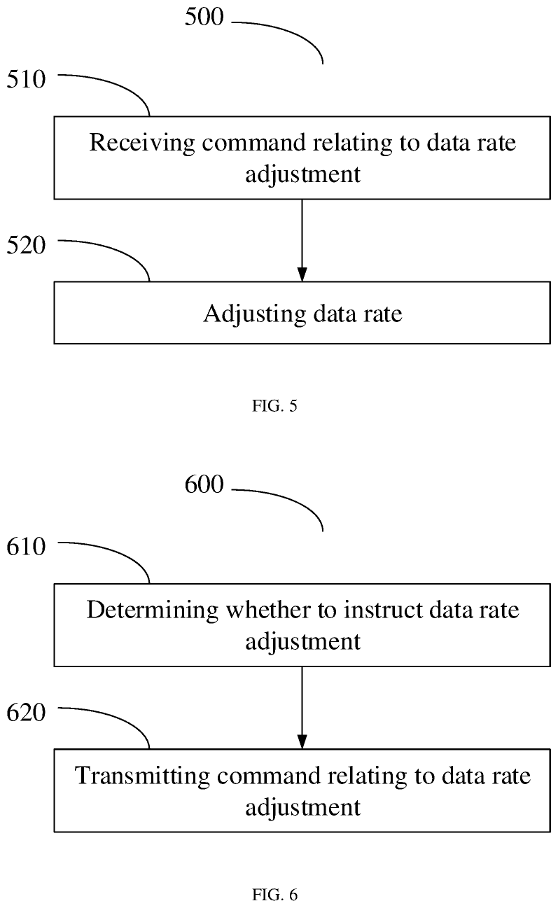

FIG. 5 shows a flow chart illustrating an example method 500 for data rate adjustment according to the example embodiments of the present disclosure. The example method 500 may be performed for example by a terminal device such as the UE 110.

Referring to the FIG. 5, the example method 500 may include an operation 510 of receiving from a network device, a command relating to an adjustment of a data rate; and an operation 520 of adjusting the data rate according to the command.

Details of the operation 510 have been described in the above descriptions with respect to at least the command 264, and repetitive descriptions thereof are omitted here.

Details of the operation 520 have been described in the above descriptions with respect to at least the operation 212, and repetitive descriptions thereof are omitted here.

In an embodiment, the command may comprise a step of the adjustment, and in a case where the command relates to an increase of the data rate, the adjusting of the data rate may comprise: determining whether to increase the data rate; and increasing the data rate by the step or according to a capability of supporting the data rate of the terminal device in case of determining to increase the data rate. The more details have been described in the above descriptions with respect to at least the operation 214 and the operation 216, and repetitive descriptions thereof are omitted here.

In an embodiment, refraining from increasing the data rate may be determined in a case where the capability of supporting the data rate increased by the step is absent in the terminal device. The more details have been described in the above descriptions with respect to at least the operation 214, and repetitive descriptions thereof are omitted here.

In an embodiment, whether to increase the data rate may be determined based on at least one of the following: the capability of supporting the data rate of the terminal device; a RF condition of the terminal device; or a requirement from a peer terminal device. The more details have been described in the above descriptions with respect to at least the operation 214, and repetitive descriptions thereof are omitted here.

In an embodiment, the command may comprise a step of the adjustment, and in a case where the command relates to a decrease of the data rate, the adjusting of the data rate may comprise: determining whether to decrease the data rate; and decreasing the data rate by the step or according to a capability of supporting the data rate of the terminal device in case of determining to decrease the data rate. The more details have been described in the above descriptions with respect to at least the operation 218 and the operation 220, and repetitive descriptions thereof are omitted here.

In an embodiment, refraining from decreasing the data rate may be determined in a case where the capability of supporting the data rate decreased by the step is absent in the terminal device. The more details have been described in the above descriptions with respect to at least the operation 218, and repetitive descriptions thereof are omitted here.

In an embodiment, whether to decrease the data rate may be determined based on a capability of supporting the data rate of the terminal device. The more details have been described in the above descriptions with respect to at least the operation 218, and repetitive descriptions thereof are omitted here.

FIG. 6 shows a flow chart illustrating an example method 600 for data rate adjustment according to the example embodiments of the present disclosure. The example method 600 may be performed for example by a network device such as the network device 160.

Referring to the FIG. 6, the example method 600 may include an operation 610 of determining whether to instruct a terminal device to adjust a data rate; and an operation 420 of transmitting to the terminal device, a command relating to the adjustment of the data rate in case of determining to instruct the terminal device to adjust the data rate.

Details of the operation 610 have been described in the above descriptions with respect to at least the operation 262, and repetitive descriptions thereof are omitted here.

Details of the operation 620 have been described in the above descriptions with respect to at least the command 264, and repetitive descriptions thereof are omitted here.

In an embodiment, whether to instruct the terminal device to adjust the data rate may be determined based on at least one of the following: overload status of the network device, or capacity requirement of the network device. The more details have been described in the above descriptions with respect to at least the operation 262, and repetitive descriptions thereof are omitted here.

In an embodiment, the command may comprise a step for the terminal device to adjust the data rate. The more details have been described in the above descriptions with respect to at least the command 264, and repetitive descriptions thereof are omitted here.

In an embodiment, the command may be transmitted in at least one form of the following: unicast, multicast, or broadcast.

In an embodiment, the command may be associated with at least one of the following: uplink communication of the terminal device, downlink communication of the terminal device, or uplink communication and downlink communication of the terminal device.

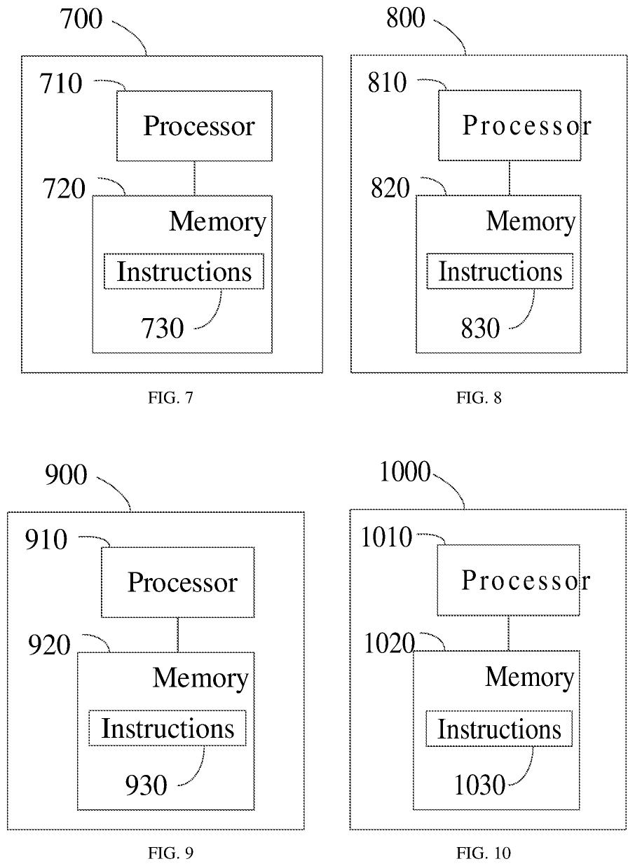

FIG. 7 shows a block diagram illustrating an example device 700 for data rate adjustment according to the example embodiments of the present disclosure. The device, for example, may be at least part of a terminal device such as the UE 110 in the above examples.

As shown in the FIG. 7, the example device 700 may include at least one processor 710 and at least one memory 720 that may store instructions 730. The instructions 730, when executed by the at least one processor 710, may cause the device 700 at least to perform the example method 300 described above.

In various example embodiments, the at least one processor 710 in the example device 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in the FIG. 7.

In various example embodiments, the at least one memory 720 in the example device 700 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 720 may include, but are not limited to, an electric, a magnetic, an optical, an electromagnetic, an infrared, or a semiconductor system, apparatus, or device or any combination of the above.

Further, in various example embodiments, the example device 700 may also include at least one other circuitry, element, and interface, for example at least one I/O interface, at least one antenna element, and the like.

In various example embodiments, the circuitries, parts, elements, and interfaces in the example device 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 700.

FIG. 8 shows a block diagram illustrating an example device 800 for data rate adjustment according to the example embodiments of the present disclosure. The device, for example, may be at least part of a network device such as the network device 160 in the above examples.

As shown in the FIG. 8, the example device 800 may include at least one processor 810 and at least one memory 820 that may store instructions 830. The instructions 830, when executed by the at least one processor 810, may cause the device 800 at least to perform the example method 400 described above.

In various example embodiments, the at least one processor 810 in the example device 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in the FIG. 8.

In various example embodiments, the at least one memory 820 in the example device 800 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 820 may include, but are not limited to, an electric, a magnetic, an optical, an electromagnetic, an infrared, or a semiconductor system, apparatus, or device or any combination of the above.

Further, in various example embodiments, the example device 800 may also include at least one other circuitry, element, and interface, for example at least one I/O interface, at least one antenna element, and the like.

In various example embodiments, the circuitries, parts, elements, and interfaces in the example device 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 160 is not limited to the above example device 800.

FIG. 9 shows a block diagram illustrating an example device 900 for data rate adjustment according to the example embodiments of the present disclosure. The device, for example, may be at least part of a terminal device such as the UE 110 in the above examples.

As shown in the FIG. 9, the example device 900 may include at least one processor 910 and at least one memory 920 that may store instructions 930. The instructions 930, when executed by the at least one processor 910, may cause the device 900 at least to perform the example method 500 described above.

In various example embodiments, the at least one processor 910 in the example device 900 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 910 may also include at least one other circuitry or element not shown in the FIG. 9.

In various example embodiments, the at least one memory 920 in the example device 900 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 920 may include, but are not limited to, an electric, a magnetic, an optical, an electromagnetic, an infrared, or a semiconductor system, apparatus, or device or any combination of the above.

Further, in various example embodiments, the example device 900 may also include at least one other circuitry, element, and interface, for example at least one I/O interface, at least one antenna element, and the like.

In various example embodiments, the circuitries, parts, elements, and interfaces in the example device 900, including the at least one processor 910 and the at least one memory 920, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 900.

FIG. 10 shows a block diagram illustrating an example device 1000 for data rate adjustment according to the example embodiments of the present disclosure. The device, for example, may be at least part of a network device such as the network device 160 in the above examples.

As shown in the FIG. 10, the example device 1000 may include at least one processor 1010 and at least one memory 1020 that may store instructions 1030. The instructions 1030, when executed by the at least one processor 1010, may cause the device 1000 at least to perform the example method 600 described above.

In various example embodiments, the at least one processor 1010 in the example device 1000 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1010 may also include at least one other circuitry or element not shown in the FIG. 10.

In various example embodiments, the at least one memory 1020 in the example device 1000 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 1020 may include, but are not limited to, an electric, a magnetic, an optical, an electromagnetic, an infrared, or a semiconductor system, apparatus, or device or any combination of the above.

Further, in various example embodiments, the example device 1000 may also include at least one other circuitry, element, and interface, for example at least one I/O interface, at least one antenna element, and the like.

In various example embodiments, the circuitries, parts, elements, and interfaces in the example device 1000, including the at least one processor 1010 and the at least one memory 1020, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 160 is not limited to the above example device 1000.

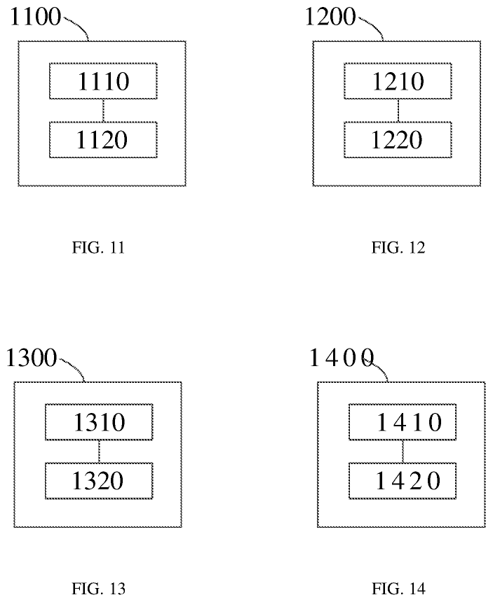

FIG. 11 shows a block diagram illustrating an example apparatus 1100 for data rate adjustment according to the example embodiments of the present disclosure. The apparatus, for example, may be at least part of a terminal device such as the UE 110 in the above examples.

As shown in FIG. 11, the example apparatus 1100 may include means 1110 for performing the operation 310 of the example method 300, and means 1120 for performing the operation 320 of the example method 300. In one or more another example embodiments, at least one I/O interface, at least one antenna element, and the like may also be included in the example apparatus 1100.

In an embodiment, the indication may comprise at least one of the following: a flag indicating the data rate is increased; the data rate increased from the first value to the second value; or a first timer starting to run upon the network device receiving the indication.

In an embodiment, the example apparatus 1100 may further include means for keeping the data rate in the second value in at least one case of the following: where a response corresponding to the indication is absent from the network device before a second timer starting to run upon transmitting the indication expires; or receiving from the network device, a message acknowledging the indication.

In an embodiment, the example apparatus 1100 may further include means for decreasing the data rate from the second value to the first value in case of receiving from the network device, a message negatively acknowledging the indication before a second timer starting to run upon transmitting the indication expires.

In an embodiment, the message negatively acknowledging the indication may comprise a third timer starting to run upon receiving the message negatively acknowledging the indication, and the example apparatus 1100 may further include means for refraining from increasing the data rate from the first value before the third timer expires.

In an embodiment, the data rate may be associated with at least one of the following: UL communication, DL communication, or UL communication and DL communication.

In some example embodiments, examples of means in the example apparatus 1100 may include circuitries. For example, an example of means 1110 may include a circuitry configured to perform the operation 310 of the example method 300, and an example of means 1120 may include a circuitry configured to perform the operation 320 of the example method 300.

The example apparatus 1100 may further include means comprising circuitry configured to perform the example method 300. In some example embodiments, examples of means may also include software modules and any other suitable function entities.

FIG. 12 shows a block diagram illustrating an example apparatus 1200 for data rate adjustment according to the example embodiments of the present disclosure. The apparatus, for example, may be at least part of a network device such as the network device 160 in the above examples.

As shown in FIG. 12, the example apparatus 1200 may include means 1210 for performing the operation 410 of the example method 400, and means 1220 for performing the operation 420 of the example method 400. In one or more another example embodiments, at least one I/O interface, at least one antenna element, and the like may also be included in the example apparatus 1200.

In an embodiment, the indication may comprise at least one of the following: a flag indicating the data rate is increased; the data rate increased from a first value to a second value; or a first timer starting to run upon the network device receiving the indication.

In an embodiment, in case of determining to acknowledge the indication, the example apparatus 1200 may further include means for refraining from transmitting to the terminal device, a response corresponding to the indication before the first timer expires; or an operation of transmitting to the terminal device, a message acknowledging the indication before the first timer expires.

In an embodiment, in case of determining to negatively acknowledge the indication, the example apparatus 1200 may further include means for transmitting to the terminal device, a message negatively acknowledging the indication requiring the terminal device to decrease the data rate before the first timer expires.

In an embodiment, the message negatively acknowledging the indication may comprise a third timer prohibiting the terminal device from increasing the data rate during the third timer run by the terminal device.

In some example embodiments, examples of means in the example apparatus 1200 may include circuitries. For example, an example of means 1210 may include a circuitry configured to perform the operation 410 of the example method 400, and an example of means 1220 may include a circuitry configured to perform the operation 420 of the example method 400.

The example apparatus 1200 may further include means comprising circuitry configured to perform the example method 400. In some example embodiments, examples of means may also include software modules and any other suitable function entities.

FIG. 13 shows a block diagram illustrating an example apparatus 1300 for data rate adjustment according to the example embodiments of the present disclosure. The apparatus, for example, may be at least part of a terminal device such as the UE 110 in the above examples.

As shown in FIG. 13, the example apparatus 1300 may include means 1310 for performing the operation 510 of the example method 500, and means 1320 for performing the operation 520 of the example method 500. In one or more another example embodiments, at least one I/O interface, at least one antenna element, and the like may also be included in the example apparatus 1300.

In an embodiment, the command may comprise a step of the adjustment, and in a case where the command relates to an increase of the data rate, the adjusting of the data rate may comprise: determining whether to increase the data rate; and increasing the data rate by the step or according to a capability of supporting the data rate of the terminal device in case of determining to increase the data rate.

In an embodiment, refraining from increasing the data rate may be determined in a case where the capability of supporting the data rate increased by the step is absent in the terminal device.

In an embodiment, whether to increase the data rate may be determined based on at least one of the following: the capability of supporting the data rate of the terminal device; a RF condition of the terminal device; or a requirement from a peer terminal device.

In an embodiment, the command may comprise a step of the adjustment, and in a case where the command relates to a decrease of the data rate, the adjusting of the data rate may comprise: determining whether to decrease the data rate; and decreasing the data rate by the step or according to a capability of supporting the data rate of the terminal device in case of determining to decrease the data rate.

In an embodiment, refraining from decreasing the data rate may be determined in a case where the capability of supporting the data rate decreased by the step is absent in the terminal device.

In an embodiment, whether to decrease the data rate may be determined based on a capability of supporting the data rate of the terminal device.

In some example embodiments, examples of means in the example apparatus 1300 may include circuitries. For example, an example of means 1310 may include a circuitry configured to perform the operation 510 of the example method 500, and an example of means 1320 may include a circuitry configured to perform the operation 520 of the example method 500.

The example apparatus 1300 may further include means comprising circuitry configured to perform the example method 500. In some example embodiments, examples of means may also include software modules and any other suitable function entities.

FIG. 14 shows a block diagram illustrating an example apparatus 1400 for data rate adjustment according to the example embodiments of the present disclosure. The apparatus, for example, may be at least part of a network device such as the network device 160 in the above examples.

As shown in FIG. 14, the example apparatus 1400 may include means 1410 for performing the operation 610 of the example method 600, and means 1420 for performing the operation 620 of the example method 600. In one or more another example embodiments, at least one I/O interface, at least one antenna element, and the like may also be included in the example apparatus 12400.

In an embodiment, whether to instruct the terminal device to adjust the data rate may be determined based on at least one of the following: overload status of the network device, or capacity requirement of the network device.

In an embodiment, the command may comprise a step for the terminal device to adjust the data rate.

In an embodiment, the command may be transmitted in at least one form of the following: unicast, multicast, or broadcast.

In an embodiment, the command may be associated with at least one of the following: uplink communication of the terminal device, downlink communication of the terminal device, or uplink communication and downlink communication of the terminal device.

The example embodiments of the present disclosure also provide a computer readable medium comprising program instructions that, when executed by a terminal device such as the UE 110 in the above examples, may cause the terminal device at least to perform: increasing a data rate from a first value to a second value; and transmitting to a network device, an indication indicating the data rate is increased.

In an embodiment, the indication may comprise at least one of the following: a flag indicating the data rate is increased; the data rate increased from the first value to the second value; or a first timer starting to run upon the network device receiving the indication.

In an embodiment, the computer readable medium may further include instructions that, when executed by the terminal device, may cause the terminal device to further perform: keeping the data rate in the second value in at least one case of the following: where a response corresponding to the indication is absent from the network device before a second timer starting to run upon transmitting the indication expires; or receiving from the network device, a message acknowledging the indication.

In an embodiment, the computer readable medium may further include instructions that, when executed by the terminal device, may cause the terminal device to further perform: decreasing the data rate from the second value to the first value in case of receiving from the network device, a message negatively acknowledging the indication before a second timer starting to run upon transmitting the indication expires.

In an embodiment, the message negatively acknowledging the indication may comprise a third timer starting to run upon receiving the message negatively acknowledging the indication, and the computer readable medium may further include instructions that, when executed by the terminal device, may cause the terminal device to further perform: refraining from increasing the data rate from the first value before the third timer expires.

In an embodiment, the data rate may be associated with at least one of the following: UL communication, DL communication, or UL communication and DL communication.

The example embodiments of the present disclosure also provide a computer readable medium comprising program instructions that, when executed by a network device such as the network device 160 in the above examples, may cause the network device at least to perform: receiving from a terminal device, an indication indicating the data rate is increased; and determining whether to acknowledge or negatively acknowledge the indication.

In an embodiment, the indication may comprise at least one of the following: a flag indicating the data rate is increased; the data rate increased from a first value to a second value; or a first timer starting to run upon the network device receiving the indication.

In an embodiment, in case of determining to acknowledge the indication, the computer readable medium may further include instructions that, when executed by the network device, may cause the network device to further perform: refraining from transmitting to the terminal device, a response corresponding to the indication before the first timer expires; or an operation of transmitting to the terminal device, a message acknowledging the indication before the first timer expires.

In an embodiment, in case of determining to negatively acknowledge the indication, the computer readable medium may further include instructions that, when executed by the network device, may cause the network device to further perform: transmitting to the terminal device, a message negatively acknowledging the indication requiring the terminal device to decrease the data rate before the first timer expires.

In an embodiment, the message negatively acknowledging the indication may comprise a third timer prohibiting the terminal device from increasing the data rate during the third timer run by the terminal device.

The example embodiments of the present disclosure also provide a computer readable medium comprising program instructions that, when executed by a terminal device such as the UE 110 in the above examples, may cause the terminal device at least to perform: receiving from a network device, a command relating to an adjustment of a data rate; and adjusting the data rate according to the command.

In an embodiment, the command may comprise a step of the adjustment, and in a case where the command relates to an increase of the data rate, the adjusting of the data rate may comprise: determining whether to increase the data rate; and increasing the data rate by the step or according to a capability of supporting the data rate of the terminal device in case of determining to increase the data rate.

In an embodiment, refraining from increasing the data rate may be determined in a case where the capability of supporting the data rate increased by the step is absent in the terminal device.

In an embodiment, whether to increase the data rate may be determined based on at least one of the following: the capability of supporting the data rate of the terminal device; a RF condition of the terminal device; or a requirement from a peer terminal device.

In an embodiment, the command may comprise a step of the adjustment, and in a case where the command relates to a decrease of the data rate, the adjusting of the data rate may comprise: determining whether to decrease the data rate; and decreasing the data rate by the step or according to a capability of supporting the data rate of the terminal device in case of determining to decrease the data rate.

In an embodiment, refraining from decreasing the data rate may be determined in a case where the capability of supporting the data rate decreased by the step is absent in the terminal device.

In an embodiment, whether to decrease the data rate may be determined based on a capability of supporting the data rate of the terminal device.

The example embodiments of the present disclosure also provide a computer readable medium comprising program instructions that, when executed by a network device such as the network device 160 in the above examples, may cause the network device at least to perform:

In an embodiment, whether to instruct the terminal device to adjust the data rate may be determined based on at least one of the following: overload status of the network device, or capacity requirement of the network device.

In an embodiment, the command may comprise a step for the terminal device to adjust the data rate.

In an embodiment, the command may be transmitted in at least one form of the following: unicast, multicast, or broadcast.

In an embodiment, the command may be associated with at least one of the following: uplink communication of the terminal device, downlink communication of the terminal device, or uplink communication and downlink communication of the terminal device.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
ACK acknowledgment
AMR adaptive multi-rate
BS base station
CU centralized unit
DL downlink
DU distributed unit
eNB evolved node B
GEO geostationary orbit satellite
gNB next generation node B
LEO low earth orbit
MAC CE medium access control control element
NACK non-acknowledgment
NR new radio
NTN non-terrestrial network
RBR recommended bit rate
RF radio frequency
RTT round trip time
SIB system information block
TN terrestrial networks
UE user equipment
UL uplink
VOIP voice over internet protocol
VONR voice over new radio

1. A terminal device, comprising:
at least one processor; and
at least one memory storing instructions that, when executed by the at least one processor, cause the terminal device at least to perform:
increasing a data rate from a first value to a second value; and
transmitting to a network device, an indication indicating the data rate is increased.

2. The terminal device of claim 1, wherein the indication comprises at least one of the following:
a flag indicating the data rate is increased;
the data rate increased from the first value to the second value; or
a first timer starting to run upon the network device receiving the indication.

3. The terminal device of claim 1, wherein the instructions, when executed by the at least one processor, cause the terminal device to further perform:
keeping the data rate in the second value in at least one case of the following:
where a response corresponding to the indication is absent from the network device before a second timer starting to run upon transmitting the indication expires; or
receiving from the network device, a message acknowledging the indication.

4. The terminal device of claim 1, wherein the instructions, when executed by the at least one processor, cause the terminal device to further perform:
decreasing the data rate from the second value to the first value in case of receiving from the network device, a message negatively acknowledging the indication before a second timer starting to run upon transmitting the indication expires.

5. The terminal device of claim 4, wherein the message negatively acknowledging the indication comprises a third timer starting to run upon receiving the message negatively acknowledging the indication, and the instructions, when executed by the at least one processor, cause the terminal device to further perform:
refraining from increasing the data rate from the first value before the third timer expires.

6. The terminal device of claim 1, wherein the data rate is associated with at least one of the following: uplink communication, downlink communication, or uplink communication and downlink communication.

7.-11. (canceled)

12. A terminal device, comprising:
at least one processor; and
at least one memory storing instructions that, when executed by the at least one processor, cause the terminal device at least to perform:
receiving from a network device, a command relating to an adjustment of a data rate; and
adjusting the data rate according to the command.

13. The terminal device of claim 12, wherein the command comprises a step of the adjustment, and in a case where the command relates to an increase of the data rate, the adjusting of the data rate comprises:
determining whether to increase the data rate; and
increasing the data rate by the step or according to a capability of supporting the data rate of the terminal device in case of determining to increase the data rate.

14. The terminal device of claim 13, wherein refraining from increasing the data rate is determined in a case where the capability of supporting the data rate increased by the step is absent in the terminal device.

15. The terminal device of claim 13, wherein whether to increase the data rate is determined based on at least one of the following: the capability of supporting the data rate of the terminal device; a radio frequency condition of the terminal device; or a requirement from a peer terminal device.

16. The terminal device of claim 12, wherein the command comprises a step of the adjustment, and in a case where the command relates to a decrease of the data rate, the adjusting of the data rate comprises:
determining whether to decrease the data rate; and
decreasing the data rate by the step or according to a capability of supporting the data rate of the terminal device in case of determining to decrease the data rate.

17. The terminal device of claim 13, wherein refraining from decreasing the data rate is determined in a case where the capability of supporting the data rate decreased by the step is absent in the terminal device.

18. The terminal device of claim 16, wherein whether to decrease the data rate is determined based on a capability of supporting the data rate of the terminal device.

19.-23. (canceled)

24. A method performed by a terminal device, comprising:
increasing a data rate from a first value to a second value; and
transmitting to a network device, an indication indicating the data rate is increased.

25. The method of claim 24, wherein the indication comprises at least one of the following:
a flag indicating the data rate is increased;
the data rate increased from the first value to the second value; or
a first timer starting to run upon the network device receiving the indication.

26. The method of claim 24, further comprising:
keeping the data rate in the second value in at least one case of the following:
where a response corresponding to the indication is absent from the network device before a second timer starting to run upon transmitting the indication expires; or
receiving from the network device, a message acknowledging the indication.

27. The method of claim 24, further comprising:
decreasing the data rate from the second value to the first value in case of receiving from the network device, a message negatively acknowledging the indication before a second timer starting to run upon transmitting the indication expires.

28. The method of claim 27, wherein the message negatively acknowledging the indication comprises a third timer starting to run upon receiving the message negatively acknowledging the indication, and the method further comprises:
refraining from increasing the data rate from the first value before the third timer expires.

29. The method of claim 24, wherein the data rate is associated with at least one of the following: uplink communication, downlink communication, or uplink communication and downlink communication.

30.-62. (canceled)
